(19) United States
(12) Patent Application Publication
(10) Pub. No.: US 2010/0332854 A1
(43) Pub. Date: Dec. 30, 2010

(54) STORAGE DEVICE, METHOD OF CONTROLLING STORAGE DEVICE, AND COMPUTER PROGRAM PRODUCT

(75) Inventor: Suguru ISHII, Nagoya (JP)

Correspondence Address: Beyer Law Group LLP, P.O. BOX 1687, Cupertino, CA, 95015-1687, US

(73) Assignee: BUFFALO INC., Nagoya-shi (JP)

(21) Appl. No.: 12/821,941

(22) Filed: Jun. 23, 2010

(30) Foreign Application Priority Data
Jun. 26, 2009 (JP) 2009-151812

(51) Int. Cl. G06F 12/14

(52) U.S. Cl. 713/193; 711/103; 711/164

(57) ABSTRACT

A storage device with an authentication feature providing enhanced convenience during locking. The device is a USB hard disk designed for connection to a personal computer, and includes a disk, an access controller, and a push-button. The access controller includes an encryption/decryption module 35; and, as functions executed by the CPU, an authentication module, an authenticated status holding module, and a decryption restricting module. When the push-button is depressed (S210: YES), the access controller resets itself (Step S220). When the access controller is reset, the startup control routine is executed again, and the access controller enters the locked state requiring password authentication by an operator.

### CROSS REFERENCE TO RELATED APPLICATIONS

The present application claims the priority based on Japanese Patent Application No. 2009-151812 filed on Jun. 26, 2009, the disclosure of which is hereby incorporated by reference in its entirety.

### BACKGROUND

1. Technical Field

The present invention relates to a storage device to be externally connected with an information processing device, a method of controlling the storage device and a computer program for the storage device.

2. Description of the Related Art

Storage devices (e.g. USB flash memory) designed for external connection to a personal computer through the use of an interface that supports such a hot plug as, for example, a USB flash memory are widely known. One of storage devices of this type proposed to date (e.g. JP-A-2007-35136) requires password authentication when the device is connected to a PC. With this feature, access can be rejected, that is, the device can be locked up, with respect to individuals who do not know the password.

However, the conventional technique described above encounters a problem that in order to lock the storage device, it is necessary to either disconnect the storage device from the PC or to shut off the power to the storage device, which is not always convenient when locking the device. For example, the conventional technique requires disconnecting the storage device or shutting off power to the storage device even if the user leaves his or her seat only for a moment, and this causes a sort of inconvenience.

### SUMMARY

Accordingly, it is an object of the present invention to provide enhanced convenience when locking a storage device that has an authentication feature.

The present invention, which has been made to solve the above object at least in part, can be realized in the following modes of practice or examples of application.

### First Example of Application

As a first example of application of the present invention is provided a storage device adapted for external connection to an information processing device, comprising an interface for connection to the information processing device;

a storage medium for storing data in encrypted form;

a decryption module for decrypting the data previously saved in the storage medium and requested to be read out of the storage medium by the information processing device;

an authentication module for authenticating legitimate access rights to the storage device;

an authenticated status holding module that, once authentication by the authentication module is successful, holds authenticated status thereafter, and that revokes the authenticated status when the connection to the information processing device via the interface is lost;

a decryption restricting module that allows decryption by the decryption module when the current status is the authenticated status, and that restricts decryption by the decryption module when the current status is not the authenticated status:

an operation command receiving module for receiving a prescribed operation command inputted by an operator; and

an authentication revoking module that, upon receiving the prescribed operation command by the operation command receiving module, revokes the authenticated status held by the authenticated status holding module.

According to this storage device of the first example of application, when a prescribed operation command is received from an operator, the authenticated status being held by the authenticated status holding module is revoked. When the current status is not the authenticated status, the decryption of data by the decryption module is restricted, so that the data is prevented from being read out of the storage device. An operator is therefore able to lock the storage device simply by performing the operation of sending a prescribed operation command, and thus the storage device affords enhanced convenience during locking.

### Second Example of Application

As a second example of application of the present invention is provided a method of controlling a storage device adapted for external connection to an information processing device, comprising the steps of:

authenticating legitimate access rights to the storage device;

holding authenticated status after the authentication has been approved;

saving data in a storage medium that stores data in encrypted form; allowing the decryption of data requested to be read out of the information processing device when the current status is the authenticated status;

restricting the decryption when the current status is not the authenticated status;

receiving a prescribed operation command input by an operator; and

revoking the holding of the authenticated status when the prescribed operation command is received by the operation command receiving module.

### Third Example of Application

As a third example of application of the present invention is provided a computer program product for a storage device adapted for external connection to an information processing device and including an interface for connection to the information processing device, a storage medium for storing data in encrypted form, and a decryption module for decrypting the data previously saved in the storage medium and request to be read out of the information processing device, the computer program product comprising:

a computer readable medium; and

a computer program stored on the computer readable medium, the computer program comprising:

a first portion for authenticating legitimate access rights to the storage device;

a second portion for holding the authenticated status after authentication has been secured according to the first portion, and revoking the authenticated status when the connection to the information processing device via the interface is lost;

a third portion for allowing the decryption by the decryption module when the current status is the authenticated status and restricting the decryption by the decryption module when the current status is not the authenticated status;

a fourth portion for receiving a prescribed operation command inputted by an operator;

a fifth portion for revoking the authenticated status held according to the second portion upon receiving the prescribed operation command.

### Fourth Example of Application

As a fourth example of application of the present invention is provided a computer program product for a storage device adapted for external connection to an information processing device and including an interface for connection to the information processing device, and a storage medium for storing data in encrypted form, the computer program product comprising:

a computer readable medium; and

a computer program stored on the computer readable medium, the computer program comprising:

a first portion for decrypting the data previously saved in the storage medium and requested to be read out of the information processing device;

a second portion for authenticating legitimate access rights to the storage device;

a third portion for holding the authenticated status after authentication has been secured according to the second program and revoking the authenticated status when the connection to the information processing device via the interface is lost;

a fourth portion for allowing the decryption according to the first portion when current status is the authenticated status and restricting the decryption according to the first portion when the current status is not the authenticated status;

a fifth portion for receiving a prescribed operation command inputted by an operator;

a sixth portion for revoking the authenticated status held according to the third portion upon receiving the prescribed operation command.

The method of controlling a storage device of the second example of application and the computer program product of the third and fourth examples of application have the same functions and achieve the same results, as the storage device of the first example of application.

The present invention can be realized in various modes of practice such as, for example, in the form of a computer program composed of the program codes provided to the computer program product of the third or fourth examples of application; or a data signal containing the computer program and transmitted on a carrier wave.

### BRIEF DESCRIPTION OF THE DRAWINGS

FIG. 1 schematically shows the structure of an information processing system 100 according to a first embodiment of the present invention;

FIG. 2 is a flowchart showing a startup control routine;

FIG. 3 is an illustration depicting a password authentication screen DB; and

FIG. 4 is a flowchart showing a push-button initiated control routine.

### DESCRIPTION OF THE EMBODIMENTS

The embodiments of the present invention are described below, with reference to the accompanying drawings.

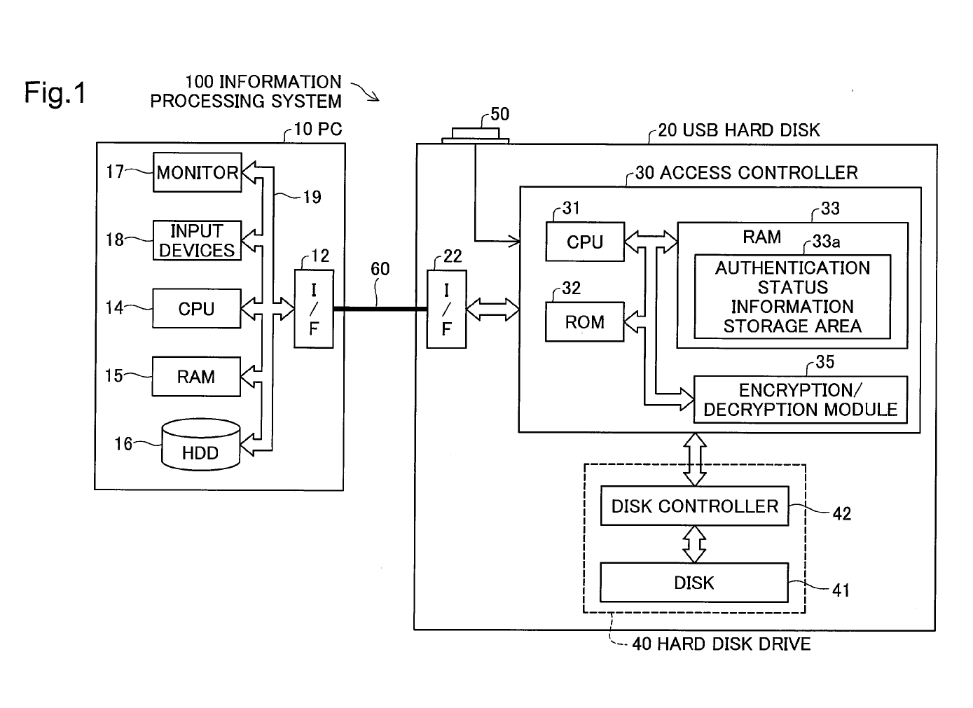

FIG. 1 is schematically shows the structure of an information processing system 100 according to a first embodiment of the present invention. As shown, the information processing system 100 includes a personal computer 10 serving as an information processing device, and a USB hard disk 20 serving as a storage device.

The personal computer (hereinafter referred to as PC) 10 comprises a USB bus interface 12, a CPU 14, a RAM 15, a hard disk drive (HDD) 16, a monitor 17 such as an LCD display, and input devices 18 such as a mouse and a keyboard. These components are interconnected via an internal bus 19.

The USB hard disk 20 consists of a USB bus interface 22, an access controller 30, and a hard disk unit 40. The USB bus interface 12 of the PC 10 and the USB bus interface 22 of the USB hard disk 20 are connected via a USB cable 60, thereby making possible data communications between the PC 10 and the USB hard disk 20 based on the USB standard.

The hard disk unit 40 includes a disk 41 as the storage medium, and a disk controller 42. The disk controller 42 performs writing and reading of data to and from the disk 41.

The access controller 30 includes a small microcomputer consisting of a CPU 31, a ROM 32, and RAM 33; and an encryption/decryption module 35. The RAM 33 contains an authentication status information storage area 33a. The authentication status information storage area 33a is a prescribed area in the RAM 33. The ROM 32 contains a computer program that describes a startup control routine and a push-button-initiated control routine, both routines being discussed later.

The access controller 30 controls access to the hard disk unit 40 from the PC 10 via the USB bus interface 22. The access controller 30 also performs communication for the purpose of carrying out various settings/control in relation to the USB connection between the USB hard disk 20 and the PC 10.

The access controller 30 executes an authentication process to authenticate legitimate access rights to the hard disk unit 40. Information indicating the status of whether authentication by this authentication process was successful (authenticated status or unauthenticated status) is saved as authentication status information in the authentication status information storage area 33a. This authentication process will be discussed in detail later.

The encryption/decryption module 35 is a hardware circuit for the purpose of enhanced security of the USB hard disk 20, and is designed to encrypt the data that is written into the disk 41 of the hard disk unit 40 and to decrypt the data that is read out of the disk 41. The encryption/decryption module 35 need not be constituted as a hardware circuit; alternatively, it may be in the form of software stored as an encryption process program in the ROM 32 and executed by the CPU 31.

A push-button 50 is installed on the casing of the USB hard disk 20. The push-button 50 is electrically connected to the access controller 30.

The push-button 50 is a switch for revoking the authenticated status mentioned previously and is to be depressed by the operator. When the push-button 50 is depressed by the operator, a revoke command is sent to the access controller 30. When the access controller 30 receives a revoke command from the push-button 50, a process to reset the access controller 30 is carried out. This process will be described later.

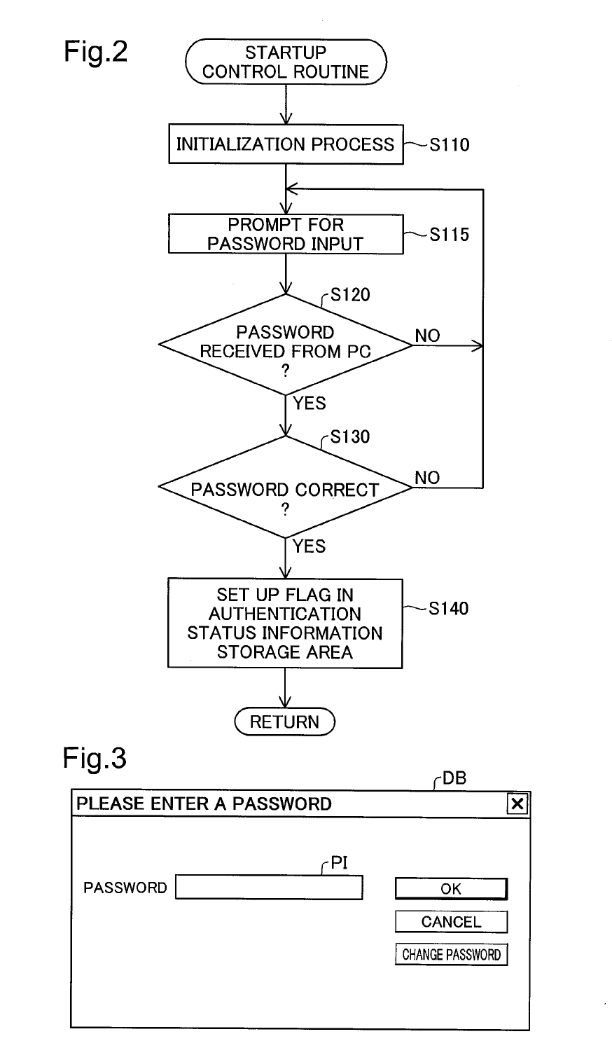

Next, a startup control routine inclusive of the aforementioned authentication process is described. FIG. 2 is a flowchart showing a startup control routine executed by the access controller 30 of the USB hard disk 20. The CPU 31 included in the access controller 30 executes the startup control routine according to a prescribed computer program stored in the ROM 32.

When the PC 10 is connected to the USB hard disk 20 (to be concrete, when connection is initiated), the USB bus interface 12 of the PC 10 electrically detects the connection of the USB hard disk 20 as a device. Generally, when the PC detects the connection of a USB-compliant device, the device, i.e. the USB hard disk 20 in this instance, executes an initialization process with the PC 10, in accordance with the USB standard specification (Step S110).

Specifically, actions such as the exchange of USB device requests, the exchange of descriptors (e.g. device classes, vendor IDs, product IDs), and the allocation of addresses to the connected device, namely, the USB hard disk 20, are executed for example. In this initialization process, the PC 10 recognizes the USB hard disk 20 and establishes the device class of the USB hard disk 20. The PC 10 also runs the device drivers corresponding to the device class so established. The “mass storage” device class is usually assigned to the USB hard disk 20 as it is a storage device.

Next, an authentication process is initiated to authenticate legitimate access rights to the USB hard disk 20. Specifically, by the help of the monitor 17 of the PC 10, the access controller 30 prompts the operator to enter a password (Step S115).

FIG. 3 is an illustration depicting a password authentication screen DB. As illustrated, the password authentication screen DB includes a password input field PI. Authentication screen data that determines the design of the password authentication screen DB is stored in advance on the disk 41, and the CPU 31 of the access controller 30 forwards this design data to the PC 10, so that the password authentication screen DB is displayed on the monitor 17 of the PC 10. In stead of being stored on the disk 41, the authentication screen data may be stored in the ROM 32.

As the password authentication screen DB appears on the monitor 17, the operator is prompted to input a password. The operator operates the input device 18 and enters a preregistered password into the password input field PI. The inputted password is then transmitted from the PC 10 to the USB hard disk 20.

In reference to FIG. 2 again, the CPU 31 of the access controller 30 decides whether a password that was inputted from the password authentication screen DB has been received via the USB bus interface 22 (Step S120). If it is decided that a password has been received (Step S120: YES), the CPU 31 looks up in an authentication table (a table storing registered passwords) that is stored on the disk 41, and decides whether the received password is correct, i.e. whether it coincides with a registered password (Step S130). In the event of a decision that the password is correct (Step S130: YES), the CPU 31 decides that authentication succeeded and sets up a flag in the authentication status information storage area 33a (Step S140).

After the execution of Step S140, the CPU 31 exits to “RETURN” and the startup control routine terminates. As a result, the CPU exits the startup control routine for displaying the password authentication screen DB, and the access to the USB hard disk 20 is enabled thereafter. The process of Steps S115 to 5130 corresponds to the “authentication module” in the first example of application; and the feature of exiting the startup control routine and being enabled to access the USB hard disk 20 corresponds to the “authenticated status holding module” in the first example of application.

On the other hand, in Step S120, if decision is made that no password has been received (Step S120: NO) or decision is made in Step S130 that the password is not correct (Step S130: NO), then the CPU 31 returns the process to Step S115. As a result, via the monitor 17 of the PC 10, the access controller 30 prompts the operator to reenter the password. Specifically, until the correct password is inputted from the password authentication screen DB, the password authentication screen DB continues to be displayed on the monitor 17 of the PC 10, and subsequent access to the USB hard disk 20 is disabled. The feature of disabling access to the USB hard disk 20 corresponds to the “encryption restricting module” in the first example of application.

As a result of executing the startup control routine described above, the authenticated status is held subsequent to a successful authentication through the authentication process, and a flag indicating the authenticated status is set (for example, “1” is set) in the authentication status information storage area 33a. On the other hand, if authentication through the authentication process is not successful, the unauthenticated status is indicated (“0” is held, for example) instead of a flag indicating an authenticated status being set in the authentication status information storage area 33a. Thus, by reading the authentication status information stored in the authentication status information storage area 33a as needed, the access controller 30 can decide whether authentication has been successful or unsuccessful.

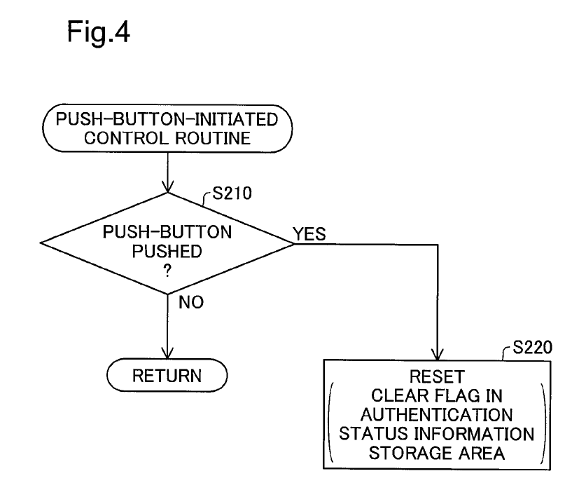

FIG. 4 is a flowchart showing a push-button initiated control routine. The CPU 31 of the access controller 30 executes the push-button initiated control routine according to a prescribed computer program stored in the ROM 32. This push-button initiated control routine is executed at prescribed time intervals (e.g. every 100 msec). When the process is initiated, the CPU 31 determines whether the operator has depressed the push-button 50 (Step S210). This determination is made on the basis of whether the aforementioned revoke command has been received from the push-button 50. In the event of a determination that the button has not been pushed (Step S210: NO), the routine exits to “RETURN” and the push-button initiated control routine terminates.

On the other hand if the determination in Step S210 is that the push-button 50 has been depressed (Step S210: YES), the CPU 31 resets the access controller 30 (Step S220). As a result of resetting, the access controller 30 is restored to its default state (the flag in the authentication status information storage area 33a is also cleared to “0”), and subsequently restarted. Upon having been restarted, the access controller 30 again executes the startup control routine described earlier, and prompts the operator to reenter the password. That is, by resetting the access controller 30 in Step S220, authentication status can be switched from authenticated status to unauthenticated status (authenticated status can be revoked). This feature corresponds to the function of the “authentication revoking module” in the first example of application.

The USB hard disk 20 is designed to switch the authentication status from authenticated status to unauthenticated status not only when the push-button 50 is depressed, but also when the PC 10 is shut down, when the power is turned off, or when the connection to the PC via the USB bus interface 22 is lost.

According to the USB hard disk 20 incorporated in the information processing system 100 with the above design, the access controller 30 resets itself when the operator depresses the push-button 50. Once the access controller 30 resets itself, the startup control process must be executed again as described above, and the operator is prompted for authentication by the password authentication screen DB. Thus, subsequent access to the USB hard disk 20 remains disabled until successful authentication again. The operator is thereby able to lock the USB hard disk 20 simply by depressing the push-button 50, and thus the USB hard disk 20 of the present embodiment affords enhanced convenience when locked.

### Modification 1:

In the preceding embodiment, the authenticated status is revoked when the access controller 30 resets itself upon receiving a revoke command from the push-button 50. Alternatively, however, the authenticated status may be revoked by allowing the USB bus interface 22 to disconnect the signal path to the access controller 30 through software execution or by automatically cutting off the power supplied to the USB hard disk 20. In fact, any procedure can be employed if it has only to be able to revoke the authenticated status.

### Modification 2:

In the preceding embodiment, in the unauthenticated state resulting from the absence of successful authentication through password authentication, any access whatsoever, inclusive of encryption of data written to the disk 41 and decryption of data read from the disk 41, is disabled. Alternatively, however, only the decryption of data may be disabled in the unauthenticated state. By doing so, only the decryption of data is disabled when the operator has depressed the push-button 50.

### Modification 3:

In the preceding embodiment, the access controller 30 resets itself immediately upon receiving a revoke command from the push-button 50. Alternatively, however, if data is in the process of being transferred between the PC 10 and the USB hard disk 20, the access controller 30 may reset itself only after the data transfer has terminated. Or, the USB hard disk 20 may be provided with an LED as an alert display. By doing so, if the push-button 50 is depressed during data transfer, the operator is warned of an error, but the access controller 30 does not reset itself.

### Modification 4:

In the preceding embodiment, the authentication status information indicating the authentication status (authenticated status or unauthenticated status) is saved in the authentication status information storage area 33a. However, the authentication status information storage area 33a may be omitted. In the preceding embodiment, because it is impossible to skip the display of the password authentication screen DB in the unauthenticated status, the authenticated status can be identified as entered if the display of the password authentication screen DB can be skipped.

### Modification 5:

While the preceding embodiment employs password authentication whereby the operator is authenticated by a password, other authentication methods may be employed, such as card authentication in which authentication is carried out with a security card such as an IC card.

### Modification 6:

In the preceding embodiment, a “push-button” type switch was employed as the switch for locking the USB hard disk 20, but this may be replaced with a switch of any type that enables the operator to send a prescribed operation command. Further, while the push-button 50 is disposed on the USB hard disk 20, the operation command may instead be sent from outside the USB hard disk 20. For example, the operator may send a lock instruction through an operation performed on the PC 10.

### Modification 7:

In the preceding embodiment, a USB hard disk was shown as an example of the storage device. However, other storage devices such as a USB flash drive (USB memory) may be substituted for the USB hard disk. The storage device may also be composed of a combination of media such as an SD card or Memory Stick and a media reader.

### Modification 8:

In the preceding embodiment, a personal computer was shown as an example of the information processing device. However, other information processing devices such as a projector, facsimile machine, router, television set, and the like may be substituted for the personal computer.

### Modification 9:

In the preceding embodiment, a USB connection interface was employed as the interface of interest, but connection to the information processing device may instead be made through a different interface such as IEEE 1394 or eSATA. In preferred practice the interface will support hot plugging.

### Modification 10:

In the preceding embodiment and modifications, some of the features implemented through hardware may instead be implemented through software, and conversely some of the features implemented through software may instead be implemented through hardware. For example, some part or all of the startup control routine and the push-button initiated control routine executed by the CPU 31 of the access controller 30 may be replaced by hardware. As a concrete example, the feature whereby the depression of the push-button is detected at the software level in Step S210 executed by the CPU, may instead be realized through a hardware circuit. Further, some part or all of the startup control routine and the push-button initiated control routine may be stored in advance on the disk 41 and executed by the disk controller 42.

### Modification 11:

In the preceding embodiment, the computer program that describes the startup control routine and the push-button initiated control routine is stored in the ROM 32 of the access controller 30, but it may be stored on the disk 41 instead. The computer program may also be distributed in the form of various recording media such as CD-ROM (computer-readable storage media); or distributed electronically through various communication means such as the Internet.

The description now turns to additional examples of application of the present invention. The storage device in accordance with the first example of application of the invention may be realized in any of the various modes of practice described below.

According to another feature of the aforementioned storage device, the authentication module includes a password prompt module that prompts the information processing device to enter a password when a connection with the information processing device is initiated, and a password decision module that performs authentication by deciding whether the password entered by the information processing device coincides with a previously registered password; and the decryption is restricted by the decryption restricting module restricting the access to the storage device. The authenticated status is revoked through resetting the storage device by the authentication revoking module.

According to this feature, the authenticated status is revoked simply by resetting the storage device, and the connection to the information processing device is resumed, so that the device can easily be shifted to the locked state requiring password authentication.

The storage device having the aforementioned feature may have the additional feature that the authenticated status holding module includes an authentication status information storage module for storing the authentication status indicating whether the current status is the authenticated status or the authentication-revoked status. According to this feature, the decision as to whether the status is the authenticated status or the unauthenticated status can be made easily based on the authentication status information stored in the authentication status information storage module.

According to yet another possible feature of the storage device of the first example of application of the invention, the device includes an encryption module for encrypting data for writing to the storage medium; and an encryption restricting module that allows the encryption by the encryption module if the current status is the authenticated status, and that restricts the encryption by the encryption module if the current status is not the authenticated status. According to this feature, both the reading of data out of the storage device and the writing of data into the storage device can be restricted when a prescribed operation command is received from the operator.

According to still another possible feature of the storage device of the first example of application of the invention, the device includes an operation switch manipulated by the operator in order to send a prescribed operation command. According to this feature, it is possible for the operator to perform the locking operation on the side of the storage device.

According to a further possible feature of the storage device of the first example of application of the invention, the operation command receiving module can receive the prescribed operation command from the information processing device. According to this feature, it is possible for the operator to perform the locking operation on the side of the information processing device.

While the invention has been described with reference to exemplary embodiments thereof, it is to be understood that the invention is not limited only to the disclosed embodiments or constructions. On the contrary, the invention is intended to cover various modifications and equivalent arrangements. In addition, while the various elements of the disclosed invention are shown in various combinations and configurations, which are exemplary, other combinations and configurations, including fewer elements or only a single element, are also within the spirit and scope of the invention.

What is claimed is:

1. A storage device adapted for external connection to an information processing device, comprising:
an interface for connection to the information processing device;
a storage medium for storing data in encrypted form;
a decryption module for decrypting data previously saved in the storage medium and requested to be read out of the storage medium by the information processing device;
an authentication module for authenticating legitimate access rights to the storage device;
an authenticated status holding module that, once authentication by the authentication module is successful, holds authenticated status thereafter, and that revokes the authenticated status when the connection to the information processing device via the interface is lost;
a decryption restricting module that allows decryption by the decryption module when the current status is the authenticated status, and that restricts decryption by the decryption module when current status is not the authenticated status;
an operation command receiving module for receiving a prescribed operation command input by an operator; and
an authentication revoking module that, upon receiving the prescribed operation command by the operation command receiving module, revokes the authenticated status held by the authenticated status holding module.

2. The storage device in accordance with claim 1, wherein
the authentication module includes:
a password prompt module that prompts the information processing device to enter a password when a connection with the information processing device is initiated; and
a password decision module that performs authentication by deciding whether the password entered by the information processing device matches a previously registered password,
wherein
the decryption restricting module restricts the decryption by restricting access to the storage device, and
the authentication revoking module revokes the authenticated status by resetting the storage device.

3. The storage device in accordance with claim 2, wherein
the authenticated status holding module includes an authentication status information storage module for storing authentication status indicating whether the current status is the authenticated status or the authentication-revoked status.

4. The storage device in accordance with claim 1 further including:
an encryption module for encrypting data to be written into the storage medium; and
an encryption restricting module that allows encryption by the encryption module when the current status is the authenticated status, and that restricts encryption by the encryption module when the current status is not the authenticated status.

5. The storage device in accordance with claim 1, further including
an operation switch to send a prescribed operation command when it is operated by the operator.

6. The storage device in accordance with claim 1, wherein
the operation command receiving module receives the prescribed operation command from the information processing device.

7. A method of controlling a storage device adapted for external connection to an information processing device, comprising the steps of:
authenticating legitimate access rights to the storage device;
holding authenticated status after authentication is secured;
saving data in a storage medium that stores data in encrypted form;
allowing the decryption of data requested to be read out of the information processing device when the current status is the authenticated status;
restricting the decryption when the current status is not the authenticated status;
receiving a prescribed operation command input by an operator; and
revoking the holding of the authenticated status when the prescribed operation command is received by the operation command receiving module.

8. A computer program product for a storage device adapted for external connection to an information processing device and including an interface for connection to the information processing device, a storage medium for storing data in encrypted form, and a decryption module for decrypting the data previously saved in the storage medium and request to be read out of the information processing device, the computer program product comprising:
a computer readable medium; and
a computer program stored on the computer readable medium, the computer program comprising:
a first portion for authenticating legitimate access rights to the storage device;
a second portion for holding the authenticated status after authentication has been secured according to the first portion, and revoking the authenticated status when the connection to the information processing device via the interface is lost;
a third portion for allowing the decryption by the decryption module when the current status is the authenticated status and restricting the decryption by the decryption module when the current status is not the authenticated status;
a fourth portion for receiving a prescribed operation command inputted by an operator;
a fifth portion for revoking the authenticated status held according to the second portion upon receiving the prescribed operation command.

9. A computer program product for a storage device adapted for external connection to an information processing device and including an interface for connection to the information processing device, and a storage medium for storing data in encrypted form, the computer program product comprising:
a computer readable medium; and
a computer program stored on the computer readable medium, the computer program comprising:
a first portion for decrypting the data previously saved in the storage medium and requested to be read out of the information processing device;
a second portion for authenticating legitimate access rights to the storage device;
a third portion for holding the authenticated status after authentication has been secured according to the second program and revoking the authenticated status when the connection to the information processing device via the interface is lost;
a fourth portion for allowing the decryption according to the first portion when current status is the authenticated status and restricting the decryption according to the first portion when the current status is not the authenticated status;
a fifth portion for receiving a prescribed operation command inputted by an operator;
a sixth portion for revoking the authenticated status held according to the third portion upon receiving the prescribed operation command.
